(19) United States
(12) Patent Application Publication
(10) Pub. No.: US 2014/0234464 A1
(43) Pub. Date: Aug. 21, 2014

(54) Hand Held Multi-Purpose Utensil

(71) Applicants: James R. Renfro, Dallas, TX (US); Ephraim R. Renfro, Dallas, TX (US); Lilian L. Renfro, Dallas, TX (US)

(72) Inventors: James R. Renfro, Dallas, TX (US); Ephraim R. Renfro, Dallas, TX (US); Lilian L. Renfro, Dallas, TX (US)

(21) Appl. No.: 13/767,963

(22) Filed: Feb. 15, 2013

(51) Int. Cl. A47J 43/28

(52) U.S. Cl. CPC A47J 43/282
USPC 425/281

(57) ABSTRACT

A hand held multi-purpose utensil of a constant diameter cylindrical handle or grip and a concave and convex shaped blade which has a curved scalloped shaped working edge. The handle or grip begins at the base of the blade and continues away from the blade along its centerline. The concave surface of the blade has regularly spaced rows of identical divots. At the base of the blade, the shape of the blade becomes convex. A portion of the handle or grip has as cross hatched pattern etched or grooved. The blade and handle is continuous with no connections or parts and comprises a volume of metal, plastic, ceramic, composite or other suitable material.

### FIELD OF THE INVENTION

This invention relates to a hand held spade for dispensing materials, specifically to dispensing ice cream, other semi-solid products and soft products.

### BACKGROUND OF THE INVENTION

1. Technical Field

The invention is a hand held utensil or spade with several features which improve efficiency and comfort for the performance of various manual tasks. Cross-hatched grooves in the handle allow the user to have a firmer grip on the utensil with less slippage. Divots in the blade reduce the surface area contacting the dispensing, material reducing friction to decrease the force necessary to move utensil through material. A scalloped edge increases the force into the dispensing material at the blade contact points than a traditional continuous edge.

2. Background Art

Prior hand held utensils, such as an ice cream spade, consist of a broad flat or hollowed-out blade with an attached handle of reducing diameter. The user grips the handle, pushes the blade into the packed material, and lifts the blade with the material on it. As the material is densely packed and partially frozen, it requires a significant force by the hand, wrist and forearm to push the blade and penetrate the material in order to recover a portion of it. The traditional ice cream spade has a handle that has a larger diameter at the base than at the top where is it is connected to the blade. With this design, when spade is gripped by user's hand and force is applied by the user, the direction of force is transmitted along the handle towards the blade. However, if the grip is not sufficiently strong, the force and the handle's decreasing diameter inevitably makes the user's hand slide along the handle and limit the maximum force which can be applied to the utensil and effectively penetrate the ice cream. This limitation can result in difficulty in dispensing the ice cream. An alternative to applying force by gripping, the handle, a user may apply force to the base of the utensil with the palm of their hand. However, applying force by this method can result in discomfort and pain in the palm of the hand.

### SUMMARY OF THE INVENTION

This invention is a new hand held spade for improving efficiency and comfort to dispense material and performing scoop tasks, such as obtaining ice cream from a refrigerated container. This invention incorporates several substantive changes in the design of the traditional spade which eliminates, reduces or corrects the problems and disadvantages discussed in the Section 2. Background Art. This invention's handle is of a constant diameter with deep cross-hatched grooves so the user will be able to get a firm grip and apply as much force as necessary while reducing the possibility of slippage. The divots in the blade are very much like the dimples found on “Santoku” knives. These divots reduce the contact surface of the blade with the dispensing material thereby requiring less force to penetrate the dispensing material. They also require less force than a spade without the divots to release the dispensing material. The blade's edge which contacts the dispensing material is scalloped shaped enabling the tip of each scallop to apply greater force to the dispensing material as compared to a traditional spade's continuous edge which applies force along all of its edge. The convex shape at the base of the spade forces the dispensing material as it is being scooped up to change from a linear direction to a vertical direction which assists in releasing the material from the blade. The invention will be manufactured as a single solid piece without moving or connected parts to: 1)eliminate potential weak connection areas prone to breakage or cracking; and 2)provide a direct and higher percentage of force to be transferred to the blade edge than a utensil made of connected parts. The invention comprises a volume of metal, plastic, ceramic, composite or other suitable material. The invention also comprises a coating such as Teflon Or another suitable material to reduce friction.

### DESCRIPTION OF THE DRAWINGS

FIG. 1 is a plan or top view of the invention showing two different types of grooves in the handle. The handle and spade is one continuous piece with no moving or connecting parts. Beginning at the base (rounded edges of the cylinder) of the invention is the grooved section. Following this section is an area suitable for embossing, engraving the name of the utensil or name of the company. The next section is relatively short and without marking. Following this section is the beginning of the spade portion of the invention. At the edge of the spade furthest from the base of the invention is the scalloped edge which encompasses approximately one-third of the total spade edge circumference.

FIG. 2 is a bottom view of the invention showing the same two groove types; and

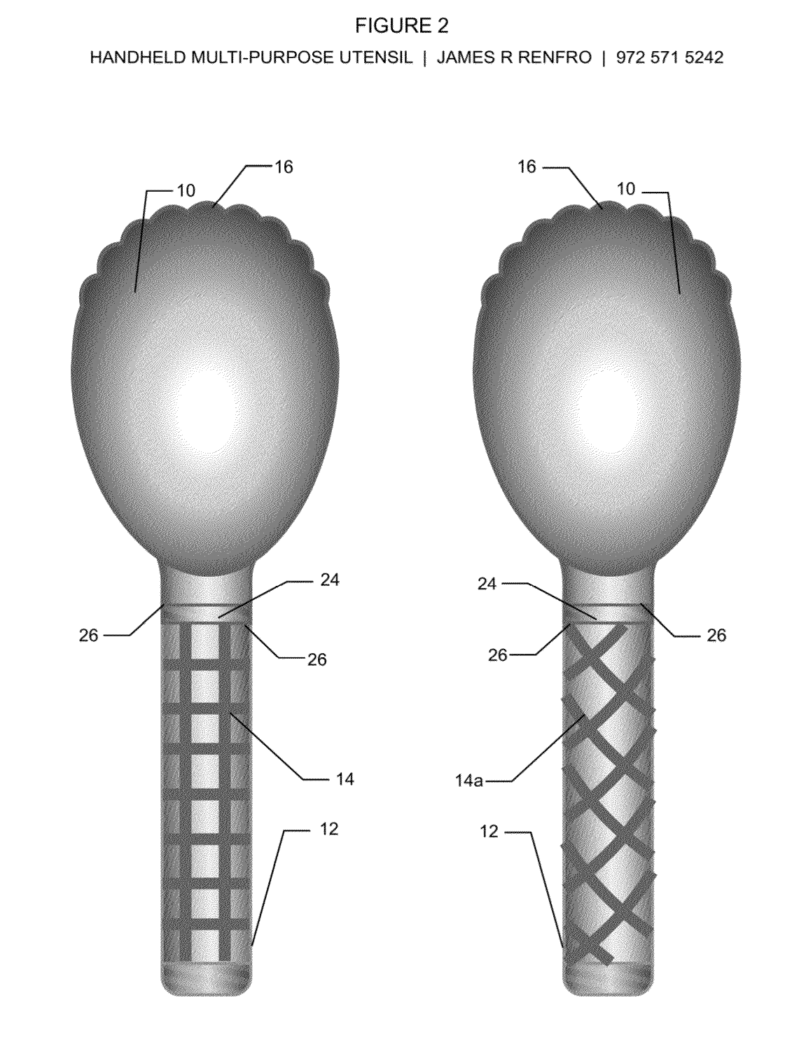

FIG. 3 is a side profile view of the two groove types in FIG. 1.

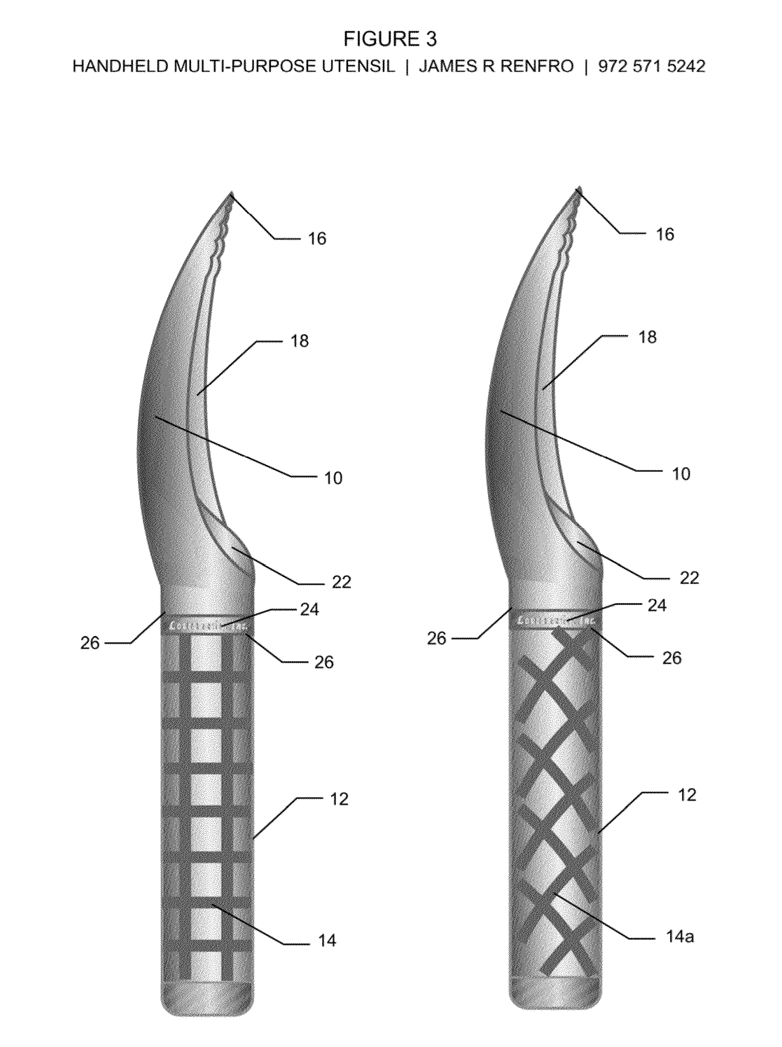

### DRAWINGS

### Reference Numerals

10 Concave and convex spade

12 Cylindrical handle

14 Straight right angle grooves in handle

14a Curved right angle grooves in handle

16 Scalloped shape edge of spade

18 Concave surface of spade

20 Divots on spade

22 Convex surface of spade

24 Designated area for engraving or embossing of utensil or company name

26 Small grooves to outline 24

### DESCRIPTION OF THE PREFERRED EMBODIMENT OF THE INVENTION

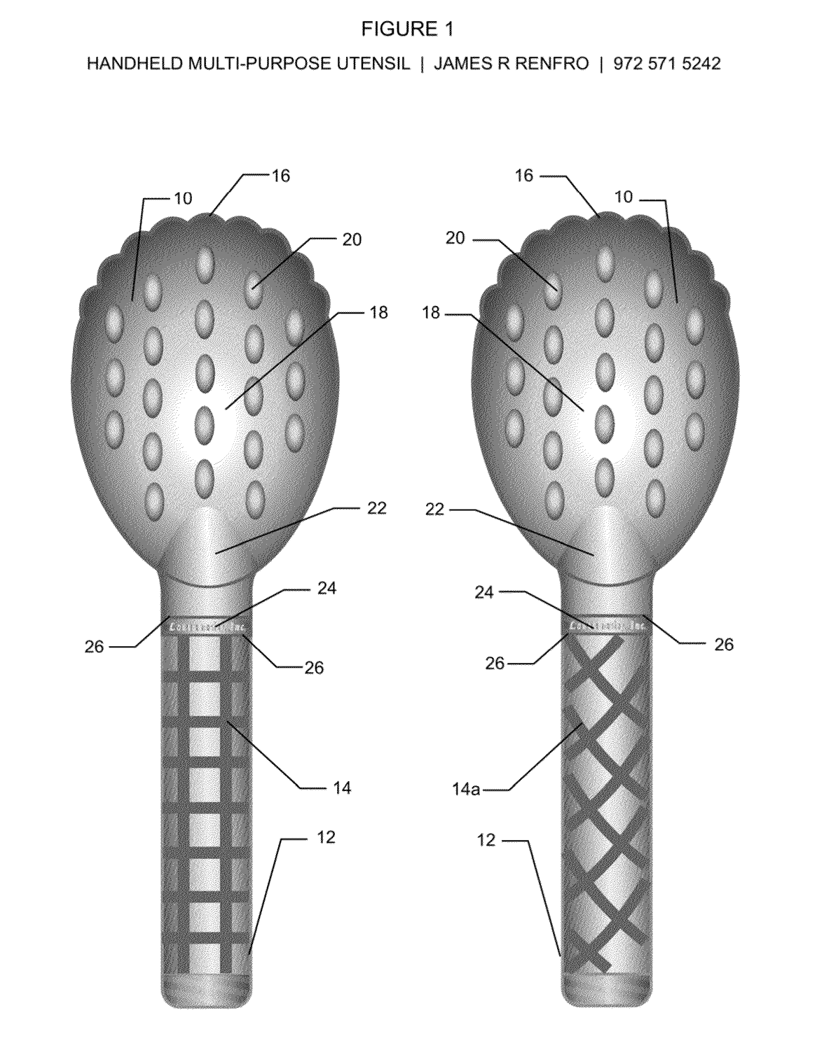

A preferred embodiment of the invention is illustrated in FIGS. 1,2 and 3. The invention has a spade 10 approximately oval in shape with dimensions of 3½ inches by 2½ inches, more or less. The handle 12 is cylindrical with a length of 5 inches and a diameter of 1 inch. The invention is a single piece with no parts. The invention consist of a hard material such as metal, plastic, ceramic, composite or other suitable material which can repeatedly be used to penetrate a soft or semi-solid material without fracturing. The invention is grasped by the handle 12 with a series of grooves 14 or 14a which provides a better grip and the invention is pushed by the hand, wrist, and forearm into the material whereby the scalloped edge of the spade 16 penetrates the material. During operations, when a portion of material is to be dispensed from a larger mass, the invention is manually pushed and through up, down and rotational movements, a portion of the material is excised from the larger mass and recovered by the concave spade portion 18 of the invention. This separated portion of material will be moved away from the larger mass along the surface of the blade. The removal of this separated portion is made easier with the divots 20 on the blade as this serves to reduce friction between the blade and the separated portion. When the separated portion nears the base of the spade, it will change its directional momentum upward through the use of the spade shape being convex 22 thus enabling easier release of the separated portion from the spade. The name of the utensil or name of the company may be embossed or engraved in the area provided by 24 and outlined by small grooves 26.

One of the most preferred uses will be the recovery and scooping of a portion of ice cream from a container of a larger mass of ice cream A coating may be applied to this invention in order to decrease it frictional component with the dispensing material by dipping, spraying, or any other suitable method. An example of a typical coating is Teflon. A coating may also be applied to provide the invention with the ability to come in various color schemes. The invention is readily manufactured by forging, casting, molding, or other common manufacturing processes.

In another embodiment, the invention is suitable to transplant flowers, vegetables, etc. easily without hurting their roots. Due to the pointed tips of the scalloped edge, it can penetrate soil easier than a conventional spade.

Another embodiment, when a longer handle 12 and a larger spade 10 is utilized, the invention can be utilized for private and commercial use in moving sand, dirt, snow, ice and other suitable materials.

What I claim is:

1. A solid single piece utensil made of metal, ceramic, plastic, composite or other suitable material comprising a concave and convex blade and a cylindrical handle to penetrate and dispense soft and semi-solid materials, particularly for rapidly and effortlessly cutting serving Port ions from a block of hard ice cream.
I claim:
The utensil of claim 1 in which the concave and convex surface of the blade have divots.
The utensil of claim 1 in which a portion of the leading edge of the blade is scalloped shaped.
The utensil of claim 1 in which the leading edge of the blade is concave but changes shape to become convex near the base of the blade.
The utensil of claim 1 in which the cylindrical handle is a constant diameter with a rounded base.
The utensil of claim 1 in which the cylindrical handle has deeply etched of carved out material comprised of straight right angle grooves.
The utensil of claim 1 in which the cylindrical handle has deeply etched or carved out material comprised of curved right angle grooves.
The utensil of claim 1 in which the blade and handle is a single solid member without parts
